(19) United States
(12) Patent Application Publication
(10) Pub. No.: US 2003/0163786 A1
(43) Pub. Date: Aug. 28, 2003

(54) Image presentation system

(76) Inventor: Harold Shields, Portland, OR (US)

Correspondence Address: Kevin L. Russell, Suite 1600, 601 SW Second Ave., Portland, OR, 97204-3157, US

(21) Appl. No.: 10/282,423

(22) Filed: Oct. 28, 2002

Related U.S. Application Data
(60) Provisional application No. 60/360,079, filed on Feb. 25, 2002.

(51) Int. Cl. G09G 5/00

(52) U.S. Cl. 715/517

(57) ABSTRACT

An image presentation system for arranging images within a graphics layout program.

### BACKGROUND OF THE INVENTION

This application claims the benefit of U.S. Provisional Application No. 60/360,079, filed Feb. 25, 2002.

The present invention relates to an image presentation system.

The designers of magazines and other brochures typically have large collections of images to select from. For example, in many cases there may be hundreds of images from which a designer may select from for a clothing catalog. Prior to selecting the images to be used in the actual catalog, the designers typically prefer to print the image on a color printer that simulates the actual professional printing press used for the final catalog, generally referred to as graphic design or pre-press.

Typically a pre-press operator desires to manipulate the color of the images to achieve the desired appearance. Frequently, the color manipulation is similar to each of the images so it is desirable to print a page filled with different images, with the color manipulation being applied to all (or a selected set of) of the images. In addition, the catalog designers may desire to view proofs of the images prior to final selection. To create an effective print of the proofs, the pre-press operator loads a set of images into a graphic layout program, such as Quark or Pagemaker, and thereafter prints the pages containing the images. Normally each page includes multiple images.

The process of creating pages containing multiple images required by most graphic layout programs includes initially locating each image to be printed. Next the pre-press operator draws a picture box within the graphic layout program for the first image. Then the pre-press operator places the first image within the picture box and then resizes the picture box to the size of the first image. The first image and associated picture box are then properly positioned within the page. Normally it is desirable to include a name for the first image, a date associated with the first image, and a time associated with the first image. To include this textual information, the pre-press operator creates a text box within the graphic layout program for the text. Then the pre-press operator types the text within the text box and then resizes the text box to the size of the text, if desired. This process is repeated for the remaining images that are to be printed on the same page. During this process, the user may manually rearrange the images and text boxes in order to attempt to reduce the amount of wasted space on the page. Unfortunately, this process of rearranging the images, manually creating picture boxes, manually creating textual boxes, loading images, typing textual information, resizing picture boxes, and resizing textual boxes takes considerable time, especially for the time necessary for navigating the graphic layout program commands, for a large number of images. In addition, the resulting page of images is likely to have errors from the manual entry of the information by the pre-press operator.

Referring to FIG. 1, one system for the assistance of pre-press operators for the proofing of images arranges image files from a directory into a graphic layout program. The layout arranges the images in the graphic layout program is in order of decreasing height from left to right with the appropriate graphic box automatically arranged around the each image. The page with the plurality of images may be manipulated and printed, as desired.

What is desired, therefore, is an image presentation system that effectively processes images for proofing.

### BRIEF DESCRIPTION OF THE DRAWINGS

FIG. 1 illustrates an existing layout technique.

FIG. 2 illustrates a modified layout technique.

FIG. 3 illustrates an image with additional information.

FIG. 4 illustrates lay up options.

### DETAILED DESCRIPTION OF THE PREFERRED EMBODIMENT

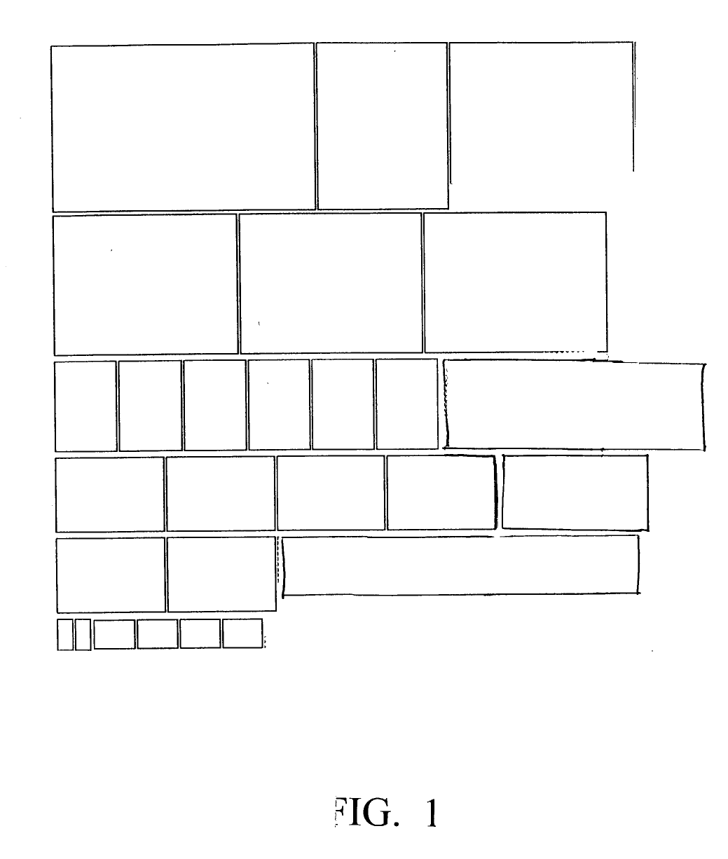

For most applications the system described with respect to FIG. 1 is effective at creating an image proof sheet. However, if the images have significantly different heights then a lot of spaces on the page remain unused. The present inventor came to the realization that some of the space that remains as a result of arranging images by height may be used by smaller images. This results in more of the page being used than would have been the case if the images were arranged in decreasing height from left to right.

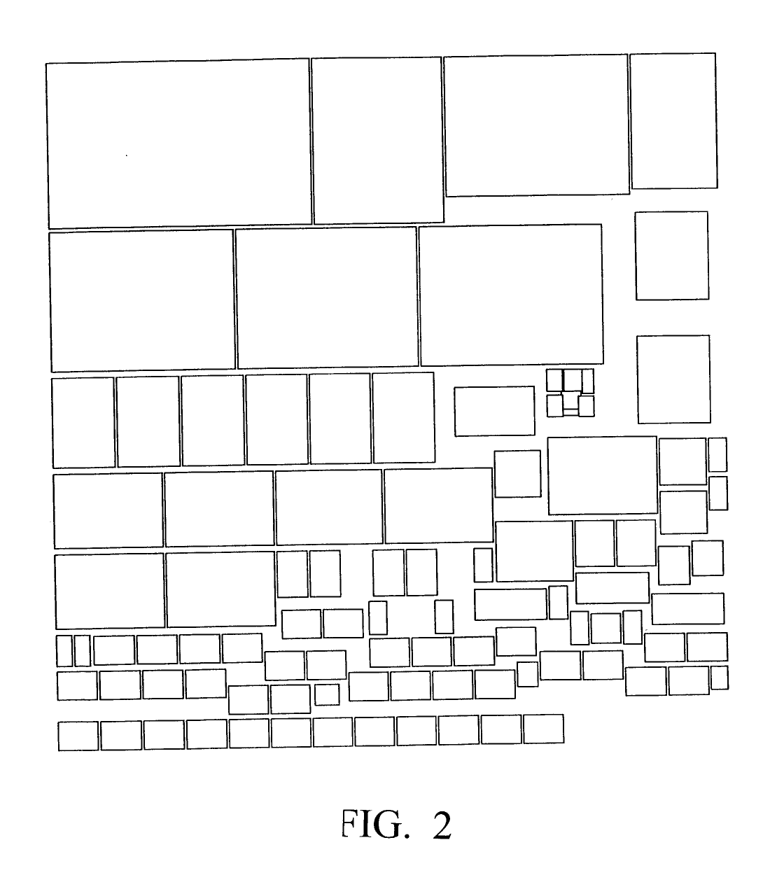

Referring to FIG. 2, the preferred technique includes arranging the images by decreasing height from left to right and top to bottom of the page. Normally all of the images are arranged with their proper orientation, namely the orientation of “upright” when the image is included. Alternatively, one or more of the images may be rotated, such as for example, 90 degrees, 103 degrees, 180 degrees, and 270 degrees. After placing an image on the page of the graphic layout program, the system selects the next image to be placed. Prior to placing the next image the system checks to see if the next image may be located in one of the openings defined between the other images that would not normally be used if the system did not check for such openings.

For example, the system may place images from left to right across the page in the order of decreasing height. On the next row of images the system may place the images starting below the initial image and proceed to place the images from left to right across the page in the order of decreasing height. Prior to placing each next image, the system may check to see if a region of sufficient size exists for the placement of the next image. For example a resulting pair of images will define an exterior bounding region defined by the rightmost edge of an image, the leftmost edge of an image, the uppermost edge of an image, and the lowermost edge of an image. The system preferably locates another image at least partially within this bounding region. The bounding region is preferably created as large as possible based upon the two images. Moreover, preferably there are no other images between the two images selected to define the exterior bounding region.

The images that are to be arranged on the page may be individually selected by the user. However, more preferably, the images to be arranged are selected from one or more directories (e.g., folders). By selection of directories including a plurality of images (or a characteristic of those images within the directories) the user avoids the necessity of manually selecting the images. This is typically most effective because the images for a particular project are normally stored within a single set of directories.

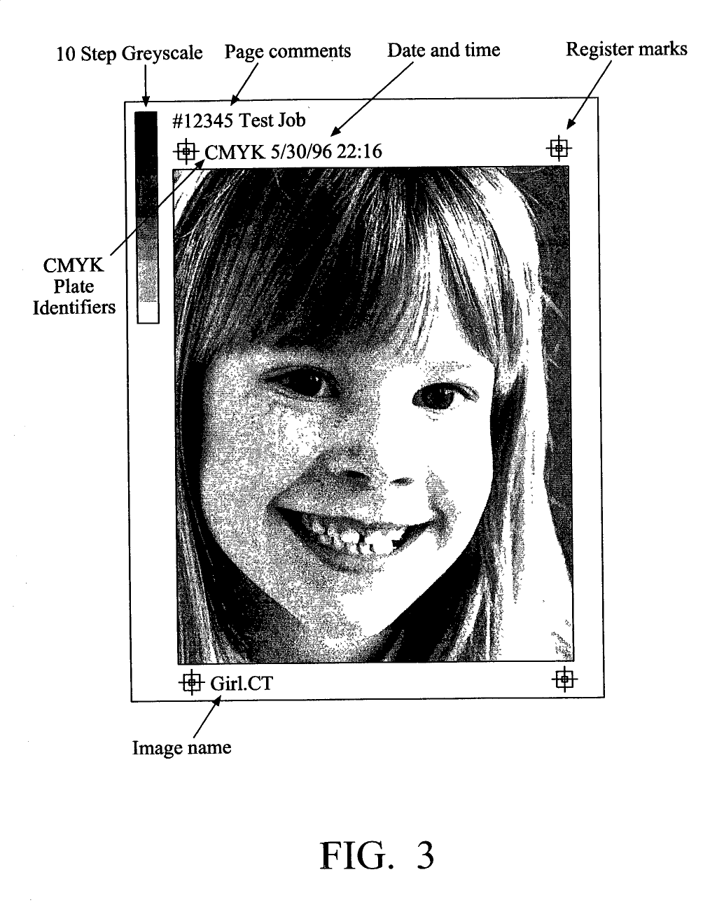

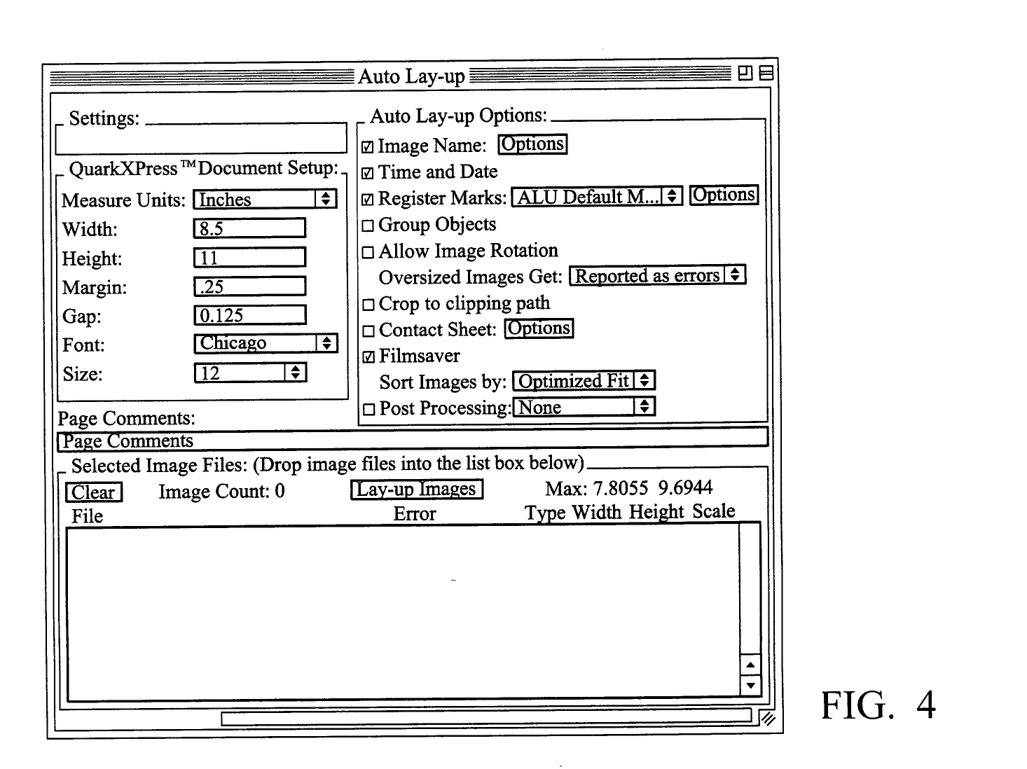

Referring to FIGS. 3 and 4, additional information may be included together with the images for purposes of identification. The color format of the image may be provided at a location outside the image itself, such as for example, sRGB, RGB, CMYK. This is useful because particular file formats may be preferable depending on the particular printing process to be used and the available image processing tools and software available. The time and date that the image was created may likewise be provided. For example, for a particular month's magazine it may be useful to ensure that all the images were created within the proper time frame, such as within the past month.

For many professional printing machines, and in particular film based printing, it is necessary to include register marks around each picture for alignment purposes. To facilitate creating film for the images registration marks are included at each of the comers of the image (or a plurality of comers). To assist in the identification of the images, the file name (or a proxy thereof) may be included together with the image.

For the image the system automatically draws a picture box within the graphic layout program, places the image within the picture box, and resizes the picture box to the size of the image, if necessary. Preferably the size of the picture box is created in a manner consistent with the size of the image. For each of register marks, names, time and date, image name, etc. (e.g., textual information) the system automatically creates a text box within the graphic layout program for the text, enters the text within the text box, and then resizes the text box to the size of the text, if desired. As it may be observed, this automatic process is relatively quick and decreases the time necessary for navigating the graphic layout program commands, for a large number of images. In addition, the resulting page of images are not likely to have errors from the manual entry of the information by the pre-press operator.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A system for arranging a set of images on a page of a graphics layout program comprising:
(a) selecting a set of images to be arranged;
(b) selecting a first image having a first height;
(b) arranging said first image on said page within said graphics layout program;
(c) selecting a second image having a second height different than said first height;
(d) arranging said second image on a page within said graphics layout program;
(e) selecting a third image having a third height different than said first height and said second height; and
(f) arranging said third image on said page within said graphics layout program at a location at least partially within in exterior bounding region defined by the rightmost edge of said first image, the leftmost edge of said second image, the uppermost edge of the taller of said first image and said second image, and the lowermost edge of said taller of said first image and said second image.

2. The system of claim 1 wherein said first, second, and third images are located within a picture box within said graphics layout program.

3. The system of claim 1 wherein said first, second, and third images are selected in a decreasing order of height.

4. The system of claim 3 wherein said first and second images are positioned from left to right on said page.

5. The system of claim 1 wherein said first, second, and third images are selected from a selected directory free from individually selecting said first, second, and third images.

6. The system of claim I further comprising including textual information representative of the color format of said first image on said page associated with said first image.

7. The system of claim 1 further comprising including textual information representative of the time and date of said first image on said page associated with said first image.

8. The system of claim 1 further comprising including a plurality of registration marks representative of the positioning of said first image on said page associated with said first image.

9. A system for arranging a set of images on a page of a graphics layout program comprising:
(a) selecting a set of images to be arranged;
(b) selecting a first image having a first height;
(b) arranging said first image on said page within said graphics layout program;
(c) selecting a second image having a second height different than said first height;
(d) arranging said second image on a page within said graphics layout program;
(e) selecting a third image having a third height different than said first height and said second height;
(f) arranging said third image on said page within said graphics layout program in a region between the spaced apart furthest distant opposing exterior edges of said first image and said second image.
(g) said first, second, and third images are located within a picture box within said graphics layout program;
(h) said first, second, and third images are selected from a selected directory free from individually selecting said first, second, and third images;
(i) including textual information representative of the color format of said first image on said page associated with said first image;
(j) including textual information representative of the time and date of said first image on said page associated with said first image; and
(k) including a plurality of registration marks representative of the positioning of said first image on said page associated with said first image.
